(19) United States
(12) Patent Application Publication
(10) Pub. No.: US 2005/0162988 A1
(43) Pub. Date: Jul. 28, 2005

(54) Method and apparatus for recording and/or reproducing data and write-once information storage medium

(75) Inventors: Sung-hee Hwang, Seoul (KR); Jung-wan Ko, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/018,867

(22) Filed: Dec. 22, 2004

(30) Foreign Application Priority Data
Jan. 5, 2004 (KR) 2004-375
May 14, 2004 (KR) 2004-34292

(51) Int. Cl. G11B 7/085; G11B 5/09; G11B 7/24

(52) U.S. Cl. 369/30.03; 369/275.3; 369/47.22

(57) ABSTRACT

A method and apparatus for recording and/or reproducing data, and a write-once information storage medium, the write-once information storage medium includes at least one data area for recording user data and at least one recording management data (RMD) area for recording RMD needed to use the at least one data area by dividing the at least one data area into a plurality of borders when recording the user data in a sequential recording mode in the at least one data area. The RMD is recorded on the write-once information storage medium and then used. When recording data on the write-once information storage medium in a sequential recording mode, a data area may be divided into a plurality of borders and/or recording zones. Thus, the write-once information storage medium can be used with enhanced ease and efficiency.

### CROSS REFERENCE TO RELATED APPLICATIONS

This application claims the priority of Korean Patent Application Nos. 2004-375 and 2004-34292, filed on Jan. 5, 2004 and May 14, 2004, respectively, in the Korean Intellectual Property Office, the disclosures of which are incorporated herein by reference.

1. Field of the Invention

The present invention relates to a write-once information storage medium including a data area which can be divided into a plurality borders, and more particularly, to a method and apparatus for recording data in a sequential recording mode when a data area is divided into a plurality of borders and/or reproducing the data, and a write-once information storage medium.

2. Description of the Related Art

Data recorded on a re-recordable information storage medium can be overwritten with new data. On the other hand, data can be recorded in a recording area of a write-once information storage medium only once. Thus, the data recorded on the write-once information storage medium cannot be overwritten with new data, nor can it be deleted or modified.

According to the conventional art, a data area of an information storage medium may be divided into a plurality of borders and user data may be recorded in units of borders to enhance ease of using the information storage medium, such as compatibility in data reproduction. According to the conventional art, when recording user data in a sequential recording mode, a data area may be divided into a plurality of recording zones, and the user data may be recorded in units of recording zones to efficiently use the data area of an information storage medium.

For example, when data is recorded on a DVD-R medium, which is one kind of conventional write-once information storage medium, in the sequential recording mode, the data area of the DVD-R medium is divided into a plurality of borders, which are sequentially used. Borders filled with data are closed and borders in which data can be recorded are open. Since each border is divided into at least one R-zone, data is recorded in units of R-zones. Here, recording management data (RMD) is recorded on the DVD-R medium. The RMD includes position information of the borders and R-zone entries containing position information of at least one R-zone included in each border. The size of the RMD is fixed, and when the RMD is updated after, for example, a new R-zone is allotted, the updated RMD is recorded on the DVD-R medium.

Since the data size of the RMD and data sizes of R-zone entries are fixed, the number of R-zone entries that can be included in one RMD is also fixed. However, according to the convention art, when a current border being used is closed and data is recorded in a new border, the resultant updated RMD still includes R-zone entries corresponding to respective R-zones in the closed border.

For example, when the number of R-zone entries that can be included in one RMD is 7,000, if 5,000 R-zones are used in a first border, a second border can use only 2,000 R-zones. Therefore, when the data size of RMD is fixed, the number of R-zone entries that can be included in one RMD is also fixed.

### SUMMARY OF THE INVENTION

In accordance with an aspect of the present invention, a write-once information storage medium storing recording management data needed to record data in a sequential recording mode by dividing a data area of the write-once information storage medium into a plurality of borders is provided.

In accordance with an aspect of the present invention, a method and apparatus for recording data on a write-once information storage medium in the sequential recording mode by dividing the data area of the write-once information storage medium into a plurality of borders are provided.

In accordance with an aspect of the present invention, a method and apparatus for reproducing data, which is recorded on the write-once information storage medium in the sequential recording mode by dividing the data area of the write-once information storage medium into a plurality of borders are provided.

According to an aspect of the present invention, there is provided a write-once information storage medium including at least one data area for recording user data; and at least one recording management data area for recording recording management data needed to use the at least one data area by dividing the at least one data area into a plurality of borders when recording the user data in a sequential recording mode in the at least one data area.

According to another aspect of the present invention, there is provided a method of recording data on a write-once information storage medium including a data area divided into a plurality of closed borders for reproduction and a last open border in which new data can be recorded. The method includes recording user data in a sequential recording mode in the last border; and creating and recording recording management data including a last border entry, which contains a starting address and a last recorded address of the last border.

According to another aspect of the present invention, there is provided a data recording apparatus recording data on a write-once information storage medium including a data area divided into a plurality of closed borders for reproduction and a last open border in which new data can be recorded. The apparatus includes a recording/reading unit recording data on the write-once information storage medium and reading the recorded data; and a controlling unit controlling the recording/reading unit to record user data in a sequential recording mode, creating recording management data including a last border entry, which contains a starting address and a last recorded address of the last border, and controlling the recording/reading unit to record the recording management data on the write-once information storage medium.

According to another aspect of the present invention, there is provided a method of reproducing data recorded on a write-once information storage medium including a data area divided into a plurality of borders. The method includes reading last recorded recording management data from the write-once information storage medium; obtaining a starting address and a last recorded address of a last border from the recording management data; determining where a last updated file system was recorded based on the starting address and the last recorded address of the last border; and reading and reproducing the last updated file system.

According to another aspect of the present invention, there is provided a data reproducing apparatus reproducing data recorded on a write-once information storage medium including a data area divided into a plurality of borders. The apparatus includes a reading unit reading data recorded on the write-once information storage medium; and a controlling unit controlling the reading unit to read last recorded recording management data from the write-once information storage medium, determining where a last updated file system was recorded based on a starting address and a last recorded address of a last border included in the recording management data, and controlling the reading unit to read the last updated file system from the write-once information storage medium.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates the structure of a single-recording-layer-write-once information storage medium according to an embodiment of the present invention;

FIG. 2 illustrates the structure of a double-recording-layer-write-once information storage medium according to an embodiment of the present invention;

FIGS. 3A and 3B are views for illustrating a method of updating recording management data (RMD) in an RMD area according to an embodiment of the present invention;

FIG. 4 illustrates a format of RMD for a sequential recording mode according to an embodiment of the present invention;

FIG. 5 illustrates the structure of a last border entry illustrated in FIG. 4 according to an embodiment of the present invention;

FIG. 6 illustrates a list of R-zone entries illustrated in FIG. 4 according to an embodiment of the present invention;

FIGS. 7A and 7B illustrate data areas where previous last open borders are closed and new last open borders are created according to embodiments of the present invention;

FIG. 8 illustrates RMD corresponding to the data area illustrated in FIG. 7A according to an embodiment of the present invention;

FIG. 9 illustrates RMD corresponding to the data area illustrated in FIG. 7B according to an embodiment of the present invention;

FIG. 10 is a block diagram of a data recording and/or reproducing apparatus according to an embodiment of the present invention;

FIG. 11 is a flowchart illustrating a method of recording data according to an embodiment of the present invention;

FIG. 12 is a flowchart illustrating operation S830 of FIG. 11 according to an embodiment of the present invention; and

FIG. 13 is a flowchart illustrating a method of reproducing data according to an embodiment of the present invention.

### DETAILED DESCRIPTION OF THE INVENTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

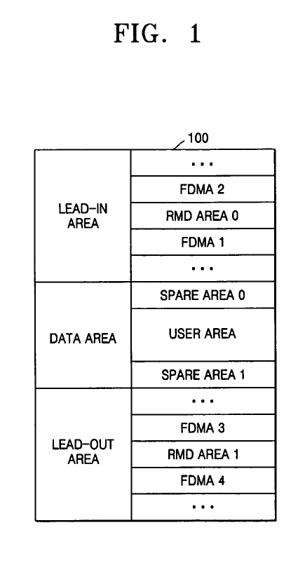

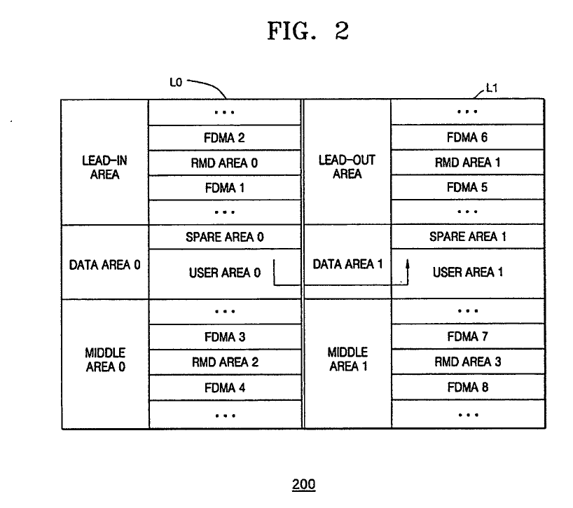

FIG. 1 illustrates the structure of a single-recording-layer-write-once information storage medium 100 according to an embodiment of the present invention. FIG. 2 illustrates the structure of a double-recording-layer-write-once information storage medium 200 according to an embodiment of the present invention.

Referring to FIG. 1, the single-recording-layer-write-once information storage medium 100 includes a lead-in area, a data area, and a lead-out area disposed sequentially from the inner circumference to the outer circumference thereof. The lead-in area includes at least one finalized disc management area (FDMA), and a recording management data (RMD) area. For example, the lead-in area includes FDMA 1, FDMA 2, and RMD area 0. The data area includes at least one spare area and a user area. For example, the data includes spare area 0 and spare area 1, and the user area. The lead-out area includes at least one FDMA and another RMD area. For example, the lead-out area includes FDMA 3 and FDMA 4, and RMD area 1.

The RMD areas are where RMD according to aspects of the present invention is recorded. A detailed description of the RMD areas will be provided below.

The spare area is an area used to replace defective user data recorded in the user area. In the present embodiment, the spare areas spare area 0 and spare area 1 are allotted to the data area by a data recording and/or reproducing apparatus or by a user's choice when the single-recording-layer-write-once information storage medium 100 is initialized.

In the present embodiment, a temporary disc defect structure (TDDS) and a temporary defect list (TDFL), which are different from the user data re-recorded for defect management are recorded in one or both of the spare areas spare area 0 and/or spare area 1 depending on an amount of defective sectors on the information storage medium.

The TDDS (not separately shown) may include a TDDS identifier, an update counter, information regarding where a last TDFL, and final disc and drive information are recorded, and information regarding the size of the spare area allotted to the data area.

The TDFL (not separately shown) may include a TDFL identifier, an update counter, a number of defective factors, and defective factors. A defective factor includes state information, position information of a defective cluster, and position information of a replacement cluster. The state information may indicate the type of defects and replacement information.

Until the single-recording-layer write-once information storage medium 100 is completed, the TDFL and TDDS in the spare area (spare area 0 and/or spare area 1) are updated at predetermined intervals. When the single-recording-layer write-once information storage medium 100 is completed, last updated TDFL and TDDS are recorded in an FDMA (FDMA 1, FDMA 2, FDMA 3 or FDMA 4) as a defect list (DFL) and a disc defect structure (DDS), respectively. In doing so, a reproducing apparatus for re-recordable information storage mediums can reproduce data from the single-recording-layer write-once information storage medium 100. The data is stored sequentially in each FDMA area such that once FDMA 1 is full then FDMA 2 is used.

Referring to FIG. 2, the double-recording-layer-write-once information storage medium 200 includes a first recording layer (L0) including a lead-in area, a first data area (data area 0), and a first middle area (middle area 0) and a second recording layer (L1) including a second middle area (middle area 1), a second data area (data area 1), and a lead-out area. The structures of the first layer L0 and the second layer L1 are almost the same as the single-recording-layer-write-once information storage medium 100 of FIG. 1. User data is recorded from the inner circumference to the outer circumference of user area 0 of the first layer L0. When the user data cannot be recorded in the user area 0 anymore, the user data is recorded in the second layer L1 from the inner circumference to the outer circumference of the user area 1.

Although not shown in FIGS. 1 and 2, when a data recording and/or reproducing apparatus is initialized to use the single-recording-layer-write-once information storage medium 100 or the double-recording-layer-write-once information storage medium 200, the RMD areas may be allotted to the data area by the data recording and/or reproducing apparatus or a user's choice in order to increase the number of times that the RMD is updated.

The RMD areas for recording only RMD are allotted to the lead-in and/or lead-out areas of the single-recording-layer-write-once information storage medium 100 of FIG. 1 and the double-recording-layer-write-once information storage medium 200 of FIG. 2. However, TDDS and RMD may be recorded together in one cluster or in separate clusters in the RMD areas.

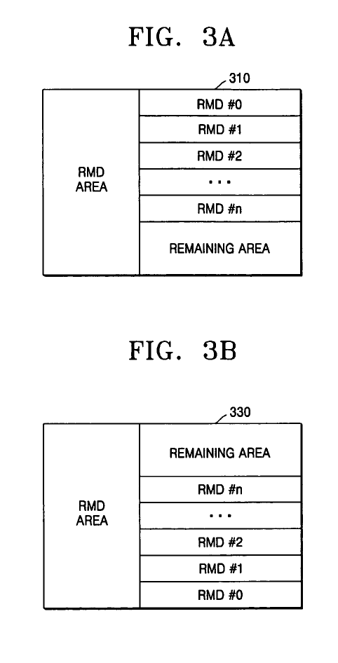

FIGS. 3A and 3B are views for illustrating a method of updating RMD in an RMD area according to an embodiment of the present invention. Referring to FIG. 3A, RMD #0 through #n is recorded from the inner circumference to the outer circumference of the RMD area 310, which is, for example, either the single-recording-layer-write-once information storage medium or the first recording layer L0 of the double-recording-layer-write-once information storage medium. Referring to FIG. 3B, RMD #0 through #n is recorded from the outer circumference to the inner circumference of the RMD area 330, which is, for example, the second recording layer L1 of the double-recording-layer-write-once information storage medium.

In the present embodiment, if the single-recording-layer-write-once information storage medium 100 or the double-recording-layer-write-once information storage medium 200 includes a plurality of RMD areas, the RMD areas are sequentially used. In other words, after an RMD area is used or filled, updated RMD is recorded in a next RMD area.

In the case of the double-recording-layer-write-once information storage medium 200 of FIG. 2, the RMb areas are sequentially used in the order of RMD area 0, RMD area 1, RMD area 2, and RMD area 3. Since the order in which the RMD areas are used and the direction in which each of the RMD areas is used are predetermined, the data recording and/or reproducing apparatus can easily and quickly access the last updated RMD recorded on the double-recording-layer-write-once information storage medium 200.

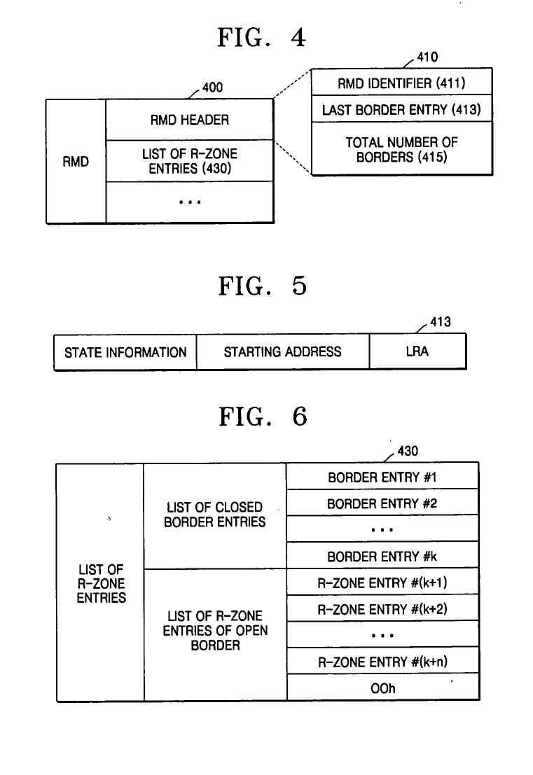

FIG. 4 illustrates a format of RMD 400 for a sequential recording mode according to an embodiment of the present invention. Referring to FIG. 4, the RMD 400 includes an RMD header 410 and a list of R-zone entries 430. The RMD header 410 includes an RMD identifier 411, a last border entry 413, and a total number of borders 415. The RMD identifier 411 is for identifying each RMD recorded in the RMD area.

The last border entry 413 is information regarding the position and state of a last border out of all the borders in the data area of the single-recording-layer-write-once information storage medium 100 or the double-recording-layer-write-once information storage medium 200. The total number of borders 415 indicates a total number of borders in the single-recording-layer-write-once information storage medium 100 or the double-recording-layer-write-once information storage medium 200.

In the present embodiment, the single-recording-layer-write-once information storage medium 100 or the double-recording-layer-write-once information storage medium 200 is used in units of borders according to the direction in which the user area is used. The last border denotes a border used last based on the direction in which the user area is used. Thus, only the last border can be an open border, and the borders before the last border are closed borders.

FIG. 5 illustrates the structure of the last border entry 413 illustrated in FIG. 4 according to an embodiment of the present invention. The last border entry 413 includes state information indicating the state of a last border, a starting address of the last border, and a last recorded address (LRA). The starting address denotes an address of a physical starting sector of the last border. The LRA denotes an address of a physical sector of a position where data is last recorded in the last border.

The state information indicates whether the last border is open such that new data can be recorded in the sequential recording mode or is a border for reproduction in which new data cannot be recorded. Such state information is available for only the last border while the state information of closed borders is included in a list of closed borders.

The total number of borders 415 illustrated in FIG. 4 indicates a starting R-zone entry number of the last border in the RMD 400. When the last border is closed, at least one R-zone included in the last border is merged such that one border becomes one R-zone.

FIG. 6 illustrates the list of R-zone entries 430 illustrated in FIG. 4 according to an embodiment of the present invention. Referring to FIG. 6, the list of R-zone entries 430 includes a “list of closed border entries” and a “list of R-zone entries of open border”. The “list of closed border entries” includes first through k^{th} (k is a variable equal to or greater than 1) border entries, which are entries of borders used before a last open border.

The “list of R-zone entries of open border” includes (k+1)^{th} through (k+n)^{th} (k and n are variables equal to or greater than 1) R-zone entries, which are entries of R-zones included in the last open border. Each of the first through k^{th} border entries includes a starting address and an LRA of each border, and each of the (k+1)^{th} through (k+n)^{th} R-zone entries includes a starting address and an LRA of each R-zone. Unlike in the case of the last border, the first through k^{th} border entries and the (k+1)^{th} through (k+n)^{th} R-zone entries do not include state information.

The reason why only the last border entry 413 includes the state information of a last border is that additional data is not recorded in the closed borders and that the closed borders are used only for reproduction of previously recorded data. Thus, it does not matter in what recording mode that the data was recorded in the closed borders. Further, if the last border is closed, it denotes that the single-recording-layer-write-once information storage medium 100 or the double-recording-layer-write-once information storage medium 200 is complete and will be used only for reproduction of the data recorded in the closed borders.

Referring to the list of R-zone entries 430, the data area of the single-recording-layer-write-once information storage medium 100 or the double-recording-layer-write-once information storage medium 200 includes k closed borders, and a last border is divided into n R-zones. As described above, whenever a last border is closed, at least one R-zone included in the last border is merged into one R-zone. Hence, each closed border is composed of one R-zone.

The data recording and/or reproducing apparatus can determine, from the total number of borders 415 illustrated in FIG. 4, that the total number of borders is (k+1) and that the (k+1)^{th} R-zone entry is a starting R-zone entry of the last border. In addition, the data recording and/or reproducing apparatus can determine where in the RMD 400 the starting R-zone entry information of the last border is stored based on the total number of borders and the starting R-zone entry number of the last border. In other words, a starting position of the first R-zone entry of the last (open) border in the RMD 400 can be calculated using the following equation:
Starting position of the first R-zone entry of the last (open) border=(length of RMD occupied by one border entry)*(“total number of borders”−1))+(starting position of “list of closed border entries”) Equation 1

As described above, each border has a border entry including a starting address of a border and an LRA. Therefore, the data recording and/or reproducing apparatus can quickly obtain information regarding the latest file system from the single-recording-layer-write-once information storage medium 100 or the double-recording-layer-write-once information storage medium 200.

For example, in the case of an universal disk format (UDF) file system, an anchor point of a closed border must be at least two out of: 1) a logical sector number 256, 2) a last logical sector number-256, or 3) a last logical sector number. Since it is possible to know the starting address and the LRA of each border in the case of the UDF file system, the data recording and/or reproducing apparatus can quickly obtain information regarding where a file system was recorded.

In addition, when closing a last border, all the R-zones in the last border are merged into one R-zone, which is represented by an R-zone entry (border entry). Thus, an open border can be divided into as many R-zones as necessary to maximize the efficiency of use of the information storage medium.

For example, when the size of the RMD 400 is fixed and the number of R-zone entries that can be included in one RMD 400 is 7,000, if 5,000 R-zones are used in the first border and thus 5,000 R-zone entries are included in the RMD, the second border can use only 2,000 R-zones. However, according to aspects of the present invention, when closing a border, if all the R-zones included in the border are merged into one R-zone represented by one R-zone (=border) entry, the second border can use 6,999 R-zones, thereby enhancing the efficiency of using the single-recording-layer-write-once information storage medium 100 or the double-recording-layer-write-once information storage medium 200.

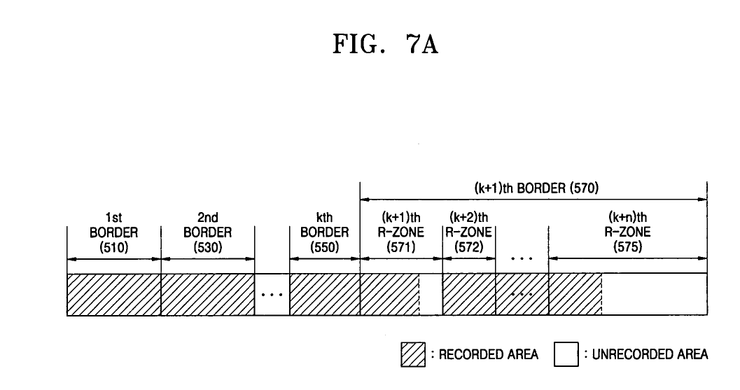

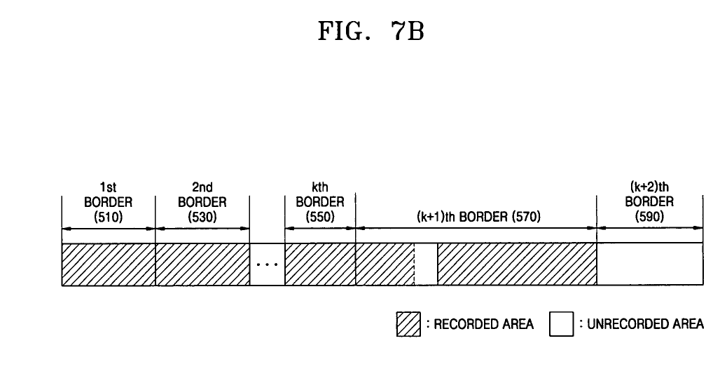

FIGS. 7A and 7B illustrate data areas where previous last open borders are closed and new last open borders are created according to embodiments of the present invention. FIG. 7A illustrates k closed borders and the (k+1)^{th} border 570, which is a last open border. The (k+1)^{th} border 570, which is the last border, includes k^{th} through (k+n)^{th} R-zones 571 through 575. Data was recorded from a first position to a second position in the (k+n)^{th} R-zone, which is the last R-zone, in the sequential recording mode.

FIG. 7B illustrates the data area where the (k+1)^{th} border 570 of FIG. 7A is closed and the (k+2)^{th} border 590, which is a new last border, is open. The (k+1)^{th} R-zone 571 through a last position of the (k+n)^{th} R-zone 575, where data was recorded, are merged into one R-zone to become the (k+1)^{th} border. In other words, the starting position of the (k+1)^{th} R-zone 571 through the last position of the (k+n)^{th} R-zone 575 where data was recorded becomes the (k+1)^{th} border that is closed.

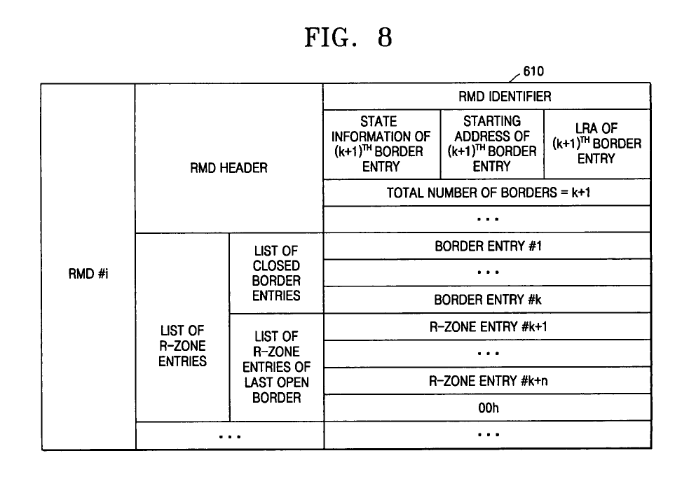

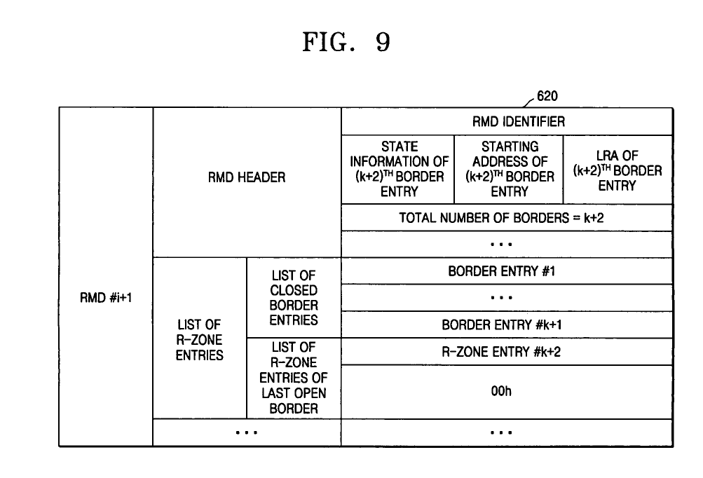

FIG. 8 illustrates RMD 610 corresponding to the data area illustrated in FIG. 7A according to an embodiment of the present invention. FIG. 9 illustrates RMD 620 corresponding to the data area illustrated in FIG. 7B according to an embodiment of the present invention.

Referring to the RMD 620 of FIG. 9, the single-recording-layer-write-once information storage medium 100 or the double-recording-layer-write-once information storage medium 200 includes (k+2) borders, and a last border entry includes the state information, the starting address, and the LRA of the (k+2)^{th} border, which is a last border.

As illustrated in FIG. 7B, if the (k+1)^{th} border, which is the previous last open border, is closed and the (k+2)^{th} border, which is the new last open border, is created, the data recording and/or reproducing apparatus updates the previous RMD 610 illustrated in FIG. 8, creates the RMD 620 illustrated in FIG. 9, and records the RMD 620 in at least one of the RMD areas. Since the last border has become the (k+2)^{th} border, the RMD 620 will be different from the previous RMD 610. The last border entry will be changed, the “total number of borders” will be increased by one, and the (k+1)^{th} border entry will be added to the “list of closed border entries.”

If a last border is closed to complete or finalize the
single-recording-layer-write-once information storage medium 100 or the
double-recording-layer-write-once information storage medium 200, there is no need to create a new last border in the data area.

As described above, if the single-recording-layer-write-once information storage medium 100 or the double-recording-layer-write-once information storage medium 200 is complete, final management information of the single-recording-layer-write-once information storage medium 100 or the double-recording-layer-write-once information storage medium 200, such as the TDFL and the TDDS, is recorded in an appropriate one of the FDMA areas. Then, the data recording and/or reproducing apparatus can access the FDMA and determine whether the single-recording-layer-write-once information storage medium 100 or the double-recording-layer-write-once information storage medium 200 is complete.

Alternatively, the last recorded RMD may be obtained, and, based on the state information of a last border entry read from the last recorded RMD, it may be determined whether the single-recording-layer-write-once information storage medium 100 or the double-recording-layer-write-once information storage medium 200 is complete.

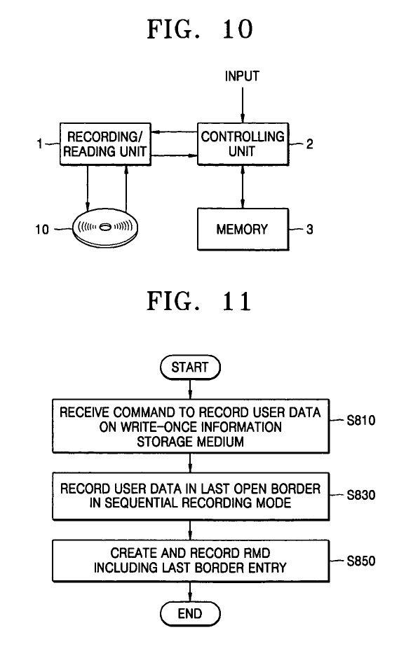

FIG. 10 is a block diagram of a data recording and/or reproducing apparatus according to an embodiment of the present invention. Referring to FIG. 10, the data recording and/or reproducing apparatus includes a recording/reading unit 1, a controlling unit 2, and a memory 3. A write-once information storage medium 10 is either the single-recording-layer-write-once information storage medium 100 or the double-recording-layer-write-once information storage medium 200 of FIG. 1 or 2, respectively, according to an embodiment of the present invention.

Controlled by the controlling unit 2, the recording/reading unit 1 records and/or reproduces data on/from the write-once information storage medium 10. After recording the data, the recording/reading unit 1 reads the recorded data to confirm the existence of the recorded data. The controlling unit 2 controls the entire operation of the data recording and/or reproducing apparatus.

After the write-once information storage medium 10 is loaded into the data recording and/or reproducing apparatus, the data recording and/or reproducing apparatus reads information, such as a last updated RMD, a TDDS, and a TDFL, from the write-once information storage medium 10 and stores the information in the memory 3. Thereafter, if user data is recorded in a last open border of the write-once information storage medium 10 in the sequential recording mode and RMD needs to be updated, the controlling unit 2 creates updated RMD with reference to the RMD, which is stored in the memory 3 and read from the write-once information storage medium 10.

A method of recording data on the write-once information storage medium 10 by the data recording and/or reproducing apparatus of FIG. 10 according to an embodiment of the present invention will now be described. FIG. 11 is a flowchart illustrating a method of recording data on the write-once information storage medium 10 according to an embodiment of the present invention.

Although not shown in the drawings, when the write-once information storage medium 10 is loaded into the data recording and/or reproducing apparatus, the data recording and/or reproducing apparatus is initialized to use the write-once information storage medium 10. In other words, the controlling unit 2 reads basic control information needed to use the write-once information storage medium 10 and the last updated TDFL, TDDS, and RMD from the lead-in area and stores the basic control information and the last updated TDFL, TDDS, and RMD in the memory 3.

The controlling unit 2 obtains the state information, the starting address and the LRA of the last border from the last updated RMD. The controlling unit 2 determines where a last updated file system was recorded based on the starting address and the LRA of the last border, reads the last updated file system, and stores the last updated file system in the memory 3.

After the data recording and/or reproducing apparatus is initialized to use the write-once information storage medium 10, if the data recording and/or reproducing apparatus receives a command to record user data on the write-once information storage medium 10 and the user data from a host (not shown) (S810), the controlling unit 2 records the user data in a specific R-zone of the last open border of the write-once information storage medium 10 in predetermined units and in the sequential recording mode (S830).

The data recording and/or reproducing apparatus creates updated RMD with reference to the RMD, which is stored in the memory 3 at predetermined timing and read from the write-once information storage medium 10, and records the updated RMD in the appropriate RMD area (S850). The structure of the updated RMD is identical to the RMD 400 of FIG. 4.

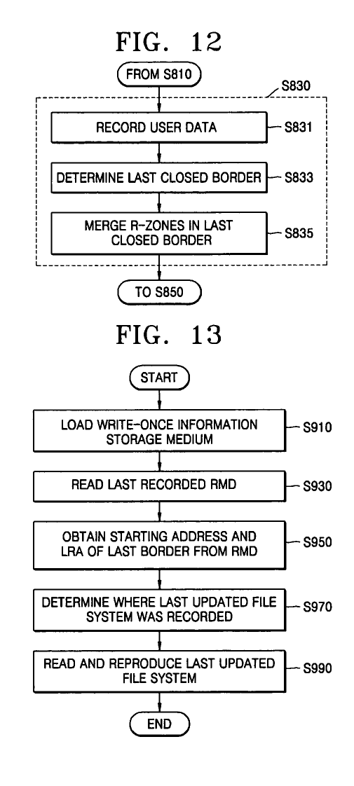

FIG. 12 is a flowchart illustrating operation S830 of FIG. 11 according to an embodiment of the present invention. User data is recorded in the last open border in units of R-zones (S831). When the last open border is closed at the command of a user or the host, the controlling unit 2 determines the extent from a starting position to a last position of the last open border where the user data was recorded as a last closed border (S833).

The controlling unit 2 merges at least one R-zone included in the last closed border into one R-zone (S835). Operations S833 and S835 may be better understood with reference to FIGS. 7A, 7B, 8 and 9.

As illustrated in FIG. 9, when closing the last open border, the controlling unit 2 creates an updated RMD and records the updated RMD in the RMD area of the write-once information storage medium 10.

As described above, when closing the last open border, the controlling unit 2 creates the updated RMD and records the updated RMD in the RMD area of the write-once information storage medium 10. The time when the RMD will be updated can be determined in diverse ways. For example, the RMD may be updated at predetermined intervals or after the completion of a round of a recording operation. Alternatively, the RMD may be updated if a predetermined amount of user data is recorded on the write-once information storage medium 10.

A method of reproducing the RMD recorded on the write-once information storage medium 10 according to an embodiment of the present invention will now be described. A data reproducing apparatus according to the present embodiment uses the data recording and/or reproducing apparatus of FIG. 10. However, since the method is for reproduction only, the recording/reading unit 1 functions as a reading unit only, and the controlling unit 2 performs only reading-related functions.

FIG. 13 is a flowchart illustrating a method of reproducing data according to an embodiment of the present invention. When the write-once information storage medium 10 is loaded into the data recording and/or reproducing apparatus (S910), the data recording and/or reproducing apparatus reads last updated RMD from the write-once information storage medium 10 and stores the last updated RMD in the memory 3 (S930).

The last updated RMD from the write-once information storage medium 10 is read when the data recording and/or reproducing apparatus is initialized to use the write-once information storage medium 10. In other words, the controlling unit 2 reads basic control information needed to use the write-once information storage medium 10 and the last updated TDFL, TDDS from the FDMA, and RMD from the RMD area in the lead-in area and stores the basic control information and the last updated TDFL, TDDS, and RMD in the memory 3.

The controlling unit 2 obtains the state information, starting address, and the LRA of the last border from the last updated RMD structured like the RMD 400 of FIG. 4 (S950). The controlling unit 2 determines where a last updated file system was recorded based on the starting address and the LRA of the last border (S970). For example, in the case of an UDF file system, an anchor point must be at least two out of logical sector number 256, last logical sector number-256, or last logical sector number in the last border. Therefore, the data reproducing apparatus can determine where the last updated file system was recorded based on the starting address and the LRA of the last border.

If the last border is open and no data has been recorded in the last border, the last updated file system may not be recorded in the last border. In this case, the controlling unit 2 obtains the starting address and the LRA of a last closed border from the list of closed border entries 430 in the RMD 400. Then, the controlling unit 2 can determine where the last updated file system was recorded based on the starting address and the LRA of the last closed border.

The controlling unit 2 reads and reproduces the last updated file system from the write-once information storage medium 10 (S990). By reproducing the last updated file system, the controlling unit 2 interprets the read file system and recognizes the type of user data recorded on the write-once information storage medium 10, the location where the user data was recorded, and a directory structure.

As described above, RMD according to aspects of the present invention is recorded on a write-once information storage medium and then used. When recording data on the write-once information storage medium in a sequential recording mode, a data area may be divided into a plurality of borders and/or recording zones. Thus, the write-once information storage medium can be used with enhanced ease and efficiency.

The present invention can also be implemented as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet).

The computer-readable recording medium can also be distributed over network-coupled computer systems so that the computer-readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

1. A write-once information storage medium, comprising:
at least one data area used to record user data; and
at least one recording management data area used to record recording management data needed to use the at least one data area by dividing the at least one data area into a plurality of borders when recording the user data in a sequential recording mode in the at least one data area.

2. The medium of claim 1, wherein the recording management data comprises a last border entry including a starting address and a last recorded address of a last border of the plurality of borders.

3. The medium of claim 2, wherein the last border entry comprises state information indicating whether the last border is a closed border for reproduction of the user data or an open border in which new data is recordable.

4. The medium of claim 2, wherein the recording management data comprises a list of closed border entries including a starting address and a last recorded address of each closed border for reproduction of the user data.

5. The medium of claim 2, wherein the recording management data comprises a list of recording zone entries of the last border, the recording zone entries including a starting address and a last recorded address of at least one recording zone included in the last border.

6. The medium of claim 3, wherein the state information indicates that the last border is closed when the write-once information storage medium is complete.

7. A method of recording data on a write-once information storage medium comprising a data area divided into a plurality of closed borders for reproduction and a last border in which new data is recordable depending on state information of the last border, the method comprising:
recording user data in a sequential recording mode in the last border; and
creating and recording recording management data including a last border entry, which contains a starting address and a last recorded address of the last border.

8. The method of claim 7, wherein the recording of the user data comprises:
dividing the last border into at least one recording zone; and
recording the user data in units of recording zones.

9. The method of claim 7, wherein the last border entry comprises the state information indicating whether the last border is closed or open.

10. The method of claim 7, wherein the recording management data comprises a list of closed border entries including starting addresses and last recorded addresses of each of the closed borders.

11. The method of claim 7, wherein the recording management data comprises a list of at least one recording zone entry of the last border, each recording zone entry including a starting address and a last recorded address of the at least one recording zone included in the last border.

12. The method of claim 9, wherein the state information indicates that the last border is closed when the write-once information storage medium is completed.

13. The method of claim 7, further comprising:
determining an extent from a starting position to a last position of the last border where the user data is recorded as a last closed border; and
merging at least one recording zone included in the last closed border into one recording zone,
wherein the creating and recording of the recording management data comprises creating and recording the recording management data including a list of closed border entries, which contain a starting address and a last recorded address of each closed border.

14. A data recording apparatus recording data on a write-once information storage medium comprising a data area divided into a plurality of closed borders for reproduction and a last open border in which new data can be recorded, the apparatus comprising:
a recording/reading unit recording data on the write-once information storage medium and reading the recorded data; and
a controlling unit controlling the recording/reading unit to record user data in a sequential recording mode, creating recording management data including a last border entry, which contains a starting address and a last recorded address of the last border, and controlling the recording/reading unit to record the recording management data on the write-once information storage medium.

15. The apparatus of claim 14, wherein the controlling unit divides the last border into at least one recording zone and controls the recording/reading unit to record the user data in units of recording zones and in the sequential recording mode.

16. The apparatus of claim 14, wherein the last border entry comprises state information indicating whether the last border is closed or open.

17. The apparatus of claim 14, wherein the recording management data comprises a list of closed border entries including starting addresses and last recorded addresses of each of the closed borders.

18. The apparatus of claim 14, wherein the recording management data comprises a list of at least one recording zone entry of the last border, each recording zone entry including a starting address and a last recorded address of at least one recording zone included in the last border.

19. The apparatus of claim 16, wherein the state information indicates that the last border is closed when the write-once information storage medium is complete.

20. The apparatus of claim 14, wherein the controlling unit determines a scope ranging from a starting position to a last position of the last border where the user data is recorded as a last closed border, merges at least one recording zone included in the last closed border into one recording zone, and creates recording management data including a list of closed border entries, which contain a starting address and a last recorded address of the last closed border.

21. A method of reproducing data recorded on a write-once information storage medium comprising a data area divided into a plurality of borders, the method comprising:
reading last recorded recording management data from the write-once information storage medium;
obtaining a starting address and a last recorded address of a last border from the recording management data;
determining where a last updated file system was recorded based on the starting address and the last recorded address of the last border; and
reading and reproducing the last updated file system.

22. The method of claim 21, wherein the last border entry comprises state information indicating whether the last border is a closed border for reproduction or an open border in which new data can be recorded.

23. The method of claim 21, wherein the recording management data comprises a list of closed border entries including the starting addresses and the last recorded addresses of each of the closed borders for reproduction.

24. The method of claim 21, wherein the recording management data comprises a list of at least one recording zone entry of the last border, the at least one recording zone entry including a starting address and a last recorded address of at least one recording zone included in the last border.

25. The method of claim 23, wherein the determining where the last updated file system was recorded comprises, obtaining the starting address and the last recorded address of a last closed border, in which the data was last recorded from the list of closed border entries if no data has been recorded in the last border, and, based on the starting address and the last recorded address of the last closed border, determining where the last updated file system was recorded.

26. A data reproducing apparatus reproducing data recorded on a write-once information storage medium comprising a data area divided into a plurality of borders, the apparatus comprising:
a reading unit reading data recorded on the write-once information storage medium; and
a controlling unit controlling the reading unit to read last recorded recording management data from the write-once information storage medium, determining where a last updated file system was recorded based on a starting address and a last recorded address of a last border included in the recording management data, and controlling the reading unit to read the last updated file system from the write-once information storage medium.

27. The apparatus of claim 26, wherein the recording management data comprising a last border entry comprises state information indicating whether the last border is a closed border for reproduction or an open border in which new data can be recorded.

28. The apparatus of claim 26, wherein the recording management data comprises a list of closed border entries including starting addresses and last recorded addresses of each closed border for reproduction.

29. The apparatus of claim 26, wherein the recording management data comprises a list of at least one recording zone entry of the last border, the at least one recording zone entry including a starting address and a last recorded address of at least one recording zone included in the last border.

30. The apparatus of claim 28, wherein if no data has been recorded in the last border, the controlling unit obtains the starting address and the last recorded address of a last closed border, in which the data was last recorded, from the list of closed border entries and, based on the starting address and the last recorded address of the last closed border, determines where a last update file system was recorded.

31. A computer-readable recording medium having recorded thereon a program for executing a method of recording data on a write-once information storage medium comprising a data area divided into a plurality of closed borders for reproduction and a last open border in which new data is recordable, the method comprising:
recording user data in a sequential recording mode in the last open border; and
creating and recording recording management data including a last border entry, which contains a starting address and a last recorded address of the last open border.

32. A computer-readable recording medium having recorded thereon a program for executing a method of reproducing data recorded on a write-once information storage medium comprising a data area divided into a plurality of borders, the method comprising:
reading last recorded recording management data from the write-once information storage medium;
obtaining a starting address and a last recorded address of a last border from the recording management data;
determining where a last updated file system was recorded based on the starting address and the last recorded address of the last border; and
reading and reproducing the last updated file system.

33. A method of using a data area of a write once information storage medium in a sequential recording mode, comprising:
recording data in the data area in a plurality of borders according to the sequential recording mode; and
generating recording management data corresponding to each of the plurality of borders, wherein a last border of the plurality of borders is open such that additional data is recordable in the last border and the recording management data for the last border comprises a last border entry including a starting address of the last border, a last recorded data address of the last border and state information indicating whether the last border is open or closed.

34. The method of claim 33, wherein the additional data is recorded in the last border in at least one recording zone.

35. The method of claim 34, further comprising:
updating the recording management data corresponding to each of the plurality of borders when the last border is closed.

36. The method of claim 34, wherein the recording management data comprises a border entry for each of the plurality of borders comprising at least a starting address and a last recorded address.

37. The method of claim 34, further comprising:
merging the at least one recording zone into a single recording zone such that the merged single recording zone forms a closed version of the last border.

38. The method of claim 37, further comprising:
updating the recording management data corresponding to each of the plurality of borders when the last border is closed.

39. The method of claim 37, further comprising:
updating the recording management data corresponding to each of the plurality of borders at predetermined intervals of time.

40. The method of claim 37, further comprising:
updating the recording management data corresponding to each of the plurality of borders after a threshold amount of the data is recorded.

41. The method of claim 37, wherein the recording management data comprises a starting address and a last recorded address of each of the borders.

42. The method of claim 37, further comprising:
updating the recording management data corresponding to each of the plurality of borders when the last border is closed; and
creating a new last border and new last border entry for a next open border such that next additional data is recordable in the new last border which starts from an end of the closed last border according to the updated recording management data.

43. The method of claim 42, wherein when the new last border is closed the write once information storage medium is complete.
